(19) United States
(12) Patent Application Publication
(10) Pub. No.: US 2009/0061805 A1
(43) Pub. Date: Mar. 5, 2009

(54) RF RECEIVER AND METHOD FOR REMOVING INTERFERENCE SIGNAL

(75) Inventors: Jong-jin Kim, Suwon-si (KR); Dae-ki Kim, Yongin-si (KR); Seung-ho Jang, Incheon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/018,572

(22) Filed: Jan. 23, 2008

(30) Foreign Application Priority Data
Sep. 5, 2007 (KR) 10-2007-0090186

(51) Int. Cl. H04B 1/10

(52) U.S. Cl. 455/296

(57) ABSTRACT

An RF receiver and a method by which the RF receiver removes interference signals are provided. The RF receiver includes a first signal processor which detects an undesired signal from RF signals received through a channel, to convert the phase of the detected signal; and a second signal processor which combines the signal output from the first signal processor with the received RF signals, to detect a desired signal. Therefore, it is possible to remove undesired signals existing on channels in which there is no overlap in frequency between desired signals and undesired signals, and accordingly an RF receiver having enhanced performance and a method by which the RF receiver removes interference signals may be provided.

### CROSS-REFERENCE TO RELATED APPLICATIONS

This application claims priority from Korean Patent Application No. 10-2007-0090186, filed on Sep. 5, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to a radio frequency (RF) receiver and a method by which the RF receiver removes interference signals. More particularly, apparatuses and methods consistent with the present invention relate to an RF receiver and an interference signal removal method capable of effectively removing interference signals, which lower the performance of the RF receiver.

2. Description of the Related Art

Wired communication or wireless communication are widely used to transceive information. Radio frequency (RF) communication is representative of wireless communication.

In RF communication systems, signals generated at baseband are converted into high-frequency passband signals and the converted signals are amplified, so that RF signals may be transmitted. In this situation, the transmitted signals are filtered to remove noise and undesired signals, and thus it is possible for only signals at desired frequency bands to be received. The received signals are amplified, and the frequency of the amplified signals is converted to baseband, so it is possible for only desired signals to be restored. Such RF communication systems receive signals transmitted through channels in order to exactly restore only desired signals, so how RF receivers function is important.

Most broadcasting communication systems employ various channels in assigned bands at the same time. Accordingly, users may receive a broadcast corresponding to a channel selected from among various channels, or broadcasts using communication channels, or may be provided with communication services. Here, all channels used to provide communication services may function as interference signals.

As a result, since both undesired signal components and desired signal components exist in RF receivers which receive RF signals through channels, it is necessary to restore desired signals without distortion at maximum. To achieve this, RF communication systems need to be linearly designed, and accordingly, power consumption may be increased or specific technologies may be required. However, RF receivers have employed integrated circuit (IC) technologies, such as RFICs or system-on-a-chip (SOC), and the operating voltage has been gradually reduced in order to reduce power consumption. Thus, there is a limit to the extent to which systems can be linearly designed by increasing power consumption.

FIG. 1 shows a conventional RF receiver which removes undesired interference signals. In FIG. 1, two antennas are used to receive RF signals. In more detail, desired signals and interference signals are simultaneously received through a first antenna 1, and only interference signals are received through a second antenna 4. The signals received through the first antenna 1 and second antenna 4 are demodulated in each individual system. Finally, an operation of subtracting the signals received through the second antenna 4 from the signals received through the first antenna 1 is performed, so that interference signals may be removed and only desired signals may be restored.

As described above, the two antennas are used in the conventional RF receiver, one of the antennas is used to receive both desired signals and interference signals, and the other is used to receive only interference signals. However, there are only a few systems capable of employing such a conventional RF receiver at present. In particular, the same two systems are required separately to use a conventional RF receiver, and the conventional RF receiver is applicable to a situation in which undesired signals are contained in the same channels of the desired signals.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention provides a radio frequency (RF) receiver capable of effectively removing undesired signals, that is, interference signals, using a plurality of signal processing routes, and an interference signal removal method thereof.

According to an aspect of the present invention, there is provided a radio frequency (RF) receiver comprising a first signal processor which detects an undesired signal from RF signals received through a channel, to convert the phase of the detected signal; and a second signal processor which combines the signal output from the first signal processor with the received RF signals, to detect a desired signal.

The second signal processor may comprise a delayer which delays the received RF signals; and a combiner which combines the signal output from the delayer with the signal output from the first signal processor.

The second signal processor may further comprise a band pass filter (BPF) which filters the received RF signals; a low noise amplifier (LNA) which low-noise amplifies the filtered signal and outputs the amplified signal to the delayer; a first down-mixer which mixes a local frequency signal with the signal output from the combiner to convert the frequency of the signal output from the combiner to baseband; and a low pass filter (LPF) which filters the signal output from the first down-mixer.

The second signal processor may further comprise a band pass filter (BPF) which filters the received RF signals and outputs the filtered signal to the delayer; a low noise amplifier (LNA) which low-noise amplifies the signal output from the combiner; a first down-mixer which mixes a local frequency signal with the signal output from the LNA to convert the frequency of the signal output from the LNA to baseband; and a low pass filter (LPF) which filters the signal output from the first down-mixer.

The first signal processor may comprise a variable amplifier which amplifies the received RF signals to control the amplitude of the received RF signals.

The first signal processor may further comprise a second down-mixer which mixes the received RF signals with a local frequency signal to convert the frequency of the received RF signals to baseband; a filtering unit which filters the signal output from the second down-mixer and outputs the filtered signal to the variable amplifier; a phase shifter which converts the phase of the signal output from the variable amplifier; an up-mixer which mixes the signal output from the phase shifter with the local frequency signal to up-convert the frequency of the signal output from the phase shifter; and an amplifier which amplifies the signal output from the up-mixer.

The first signal processor may further comprise a second down-mixer which mixes the received RF signals with a local frequency signal to down-convert the frequency of the received RF signals; a filtering unit which filters the signal output from the second down-mixer and outputs the filtered signal to the variable amplifier; an up-mixer which mixes the signal output from the variable amplifier with the local frequency signal to up-convert the frequency of the signal output from the variable amplifier; an amplifier which amplifies the signal output from the up-mixer; and a phase shifter which converts the phase of the signal output from the amplifier.

The first signal processor may further comprise a second down-mixer which mixes the received RF signals with a local frequency signal to down-convert the frequency of the received RF signals; a filtering unit which filters the signal output from the second down-mixer; a phase shifter which converts the phase of the signal output from the filtering unit; an up-mixer which mixes the signal output from the phase shifter with the local frequency signal to up-convert the frequency of the signal output from the phase shifter; an amplifier which amplifies the signal output from the up-mixer; and a variable amplifier which amplifies the signal output from the amplifier to control the amplitude of the signal output from the amplifier.

The first signal processor may further comprise a filtering unit, the second signal processor may further comprise a low pass filter (LPF), and a cut-off frequency of the filtering unit may be equal to that of the LPF.

The RF receiver may further comprise a local oscillator, which generates a local frequency signal. Each of the first signal processor and second signal processor may comprise one or more mixers which perform mixing using the same local frequency signal generated by the local oscillator.

The first signal processor may convert the phase of the detected undesired signal. The second signal processor may combine the undesired signal, of which the phase has been converted, with the RF signals, and may offset the undesired signal from the RF signals, to detect the desired signal.

According to another aspect of the present invention, there is provided a method by which a radio frequency (RF) receiver removes an interference signal, the method comprising detecting an undesired signal from RF signals received through a channel, to convert the phase of the detected signal; and combining the undesired signal, of which the phase has been converted, with the received RF signals, and offsetting the undesired signal from the RF signals, to detect a desired signal.

The combining may comprise delaying the received RF signals; and combining the delayed signals with the undesired signal of which the phase has been converted.

The combining may further comprise band-pass filtering the received RF signals; low-noise amplifying the filtered signal and outputting the amplified signal; mixing a local frequency signal with the combined signal to convert the frequency of the combined signal to baseband; and low-pass filtering the signal of which the frequency has been converted to baseband.

The combining may further comprise band-pass filtering the received RF signals and outputting the filtered signal; low-noise amplifying the combined signal; mixing a local frequency signal with the low-noise amplified signal to convert the frequency of the low-noise amplified signal to baseband; and low-pass filtering the signal of which the frequency has been converted to baseband.

The detecting may comprise amplifying the received RF signals to control the amplitude of the received RF signals.

The detecting may further comprise mixing the received RF signals with a local frequency signal to convert the frequency of the received RF signals to baseband; filtering the RF signals of which the frequency has been converted to baseband and outputting the filtered signal; mixing the signal of which the phase has been converted with the local frequency signal to convert the frequency of the signal, of which the phase has been converted, to passband; and amplifying the signal of which the frequency has been converted to passband.

The detecting may further comprise mixing the received RF signals with a local frequency signal to convert the frequency of the received RF signals to baseband; filtering the RF signals of which the frequency has been converted to baseband and outputting the filtered signal; mixing the signal of which the amplitude has been controlled with the local frequency signal to convert the frequency of the signal, of which the amplitude has been controlled, to passband; amplifying the signal of which the frequency has been converted to passband; and converting the phase of the amplified signal.

The detecting may further comprise mixing the received RF signals with a local frequency signal to convert the frequency of the received RF signals to baseband; filtering the RF signals of which the frequency has been converted to baseband; converting the phase of the filtered signal; mixing the signal of which the phase has been converted with the local frequency signal to convert the frequency of the signal, of which the phase has been converted, to passband; and amplifying the signal of which the frequency has been converted to passband.

The detecting may further comprise filtering, the combining may further comprise low-pass filtering, and the filtering and low-pass filtering may be performed using the same cut-off frequency.

The method may further comprise generating a local frequency signal. The detecting and the combining may comprise performing mixing using the same generated local frequency signal to control at least one frequency.

The detecting may comprise converting the phase of the detected undesired signal. The combining may comprise combining the undesired signal, of which the phase has been converted, with the RF signals, to detect the desired signal.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram showing a related art radio frequency (RF) receiver;

FIG. 2 is a block diagram showing an RF receiver according to an exemplary embodiment of the present invention;

FIG. 3 is a block diagram showing a second signal processor of the RF receiver according to an exemplary embodiment of the present invention;

FIG. 4 is a detailed block diagram showing the second signal processor of FIG. 3;

FIG. 5 is a block diagram showing a second signal processor of an RF receiver according to another exemplary embodiment of the present invention;

FIG. 6 is a block diagram showing a first signal processor of the RF receiver according to an exemplary embodiment of the present invention;

FIG. 7 is a detailed block diagram showing the first signal processor of FIG. 6;

FIG. 8 is a block diagram showing a first signal processor of the RF receiver according to another exemplary embodiment of the present invention;

FIG. 9 is a block diagram showing a first signal processor of the RF receiver according to yet another exemplary embodiment of the present invention;

FIGS. 10A to 10E are graphical representations showing representative signal waveforms at areas of the RF receiver according to exemplary embodiments of the present invention; and

FIG. 11 is a flowchart explaining a method by which the RF receiver removes interference signals, according to exemplary embodiments of the present invention.

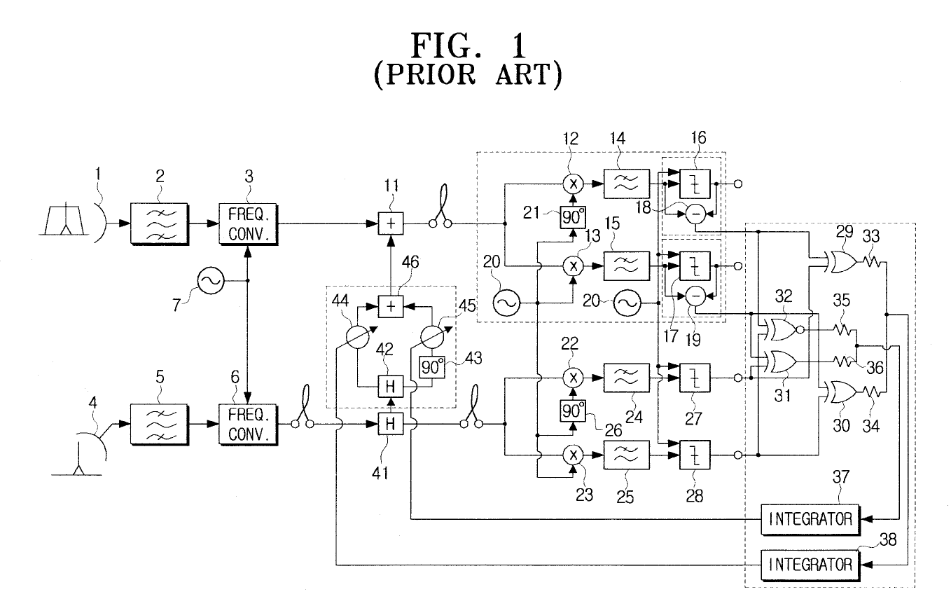

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

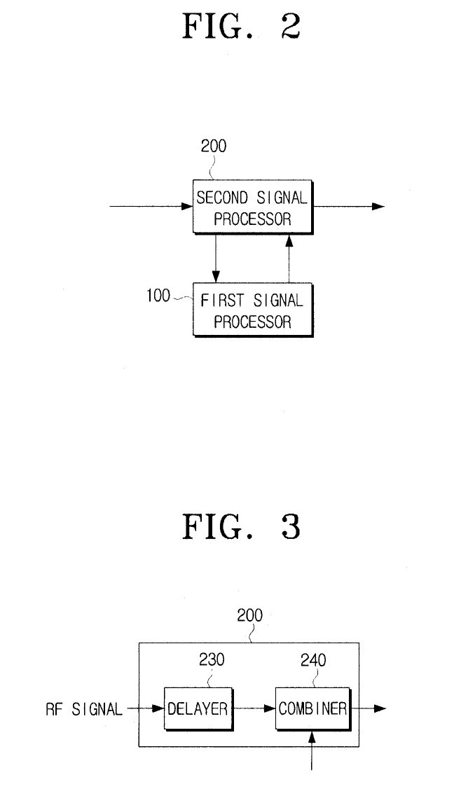

FIG. 2 is a block diagram showing a radio frequency (RF) receiver according to an exemplary embodiment of the present invention. The RF receiver of FIG. 2 comprises a first signal processor 100 and a second signal processor 200. A single signal processing route may be implemented in each signal processor.

The first signal processor 100 detects undesired signals from RF signals received through a channel, and converts the phase of the detected signals. The second signal processor 200 combines the signals output from the first signal processor 100 with the received RF signals, to detect desired signals. Specifically, the first signal processor 100 converts the phase of the undesired signals, and the second signal processor 200 combines the undesired signals having the converted phase with the RF signals and offsets the undesired signals from the RF signals, to detect the desired signals.

FIG. 3 is a block diagram showing the second signal processor 200 of the RF receiver according to an exemplary embodiment of the present invention. The second signal processor 200 of FIG. 3 comprises a delayer 230 and a combiner 240.

The delayer 230 delays the received RF signals by a predetermined time period. The combiner 240 combines the signals output from the delayer 230 with the signals output from the first signal processor 100. Specifically, the delayer 230 delays the received RF signals by the predetermined time period until the signals input to the first signal processor 100 are output to the combiner 240. Accordingly, the combiner 240 may exactly combine the signals output from the delayer 230 with the signals output from the first signal processor 100 without errors occurring.

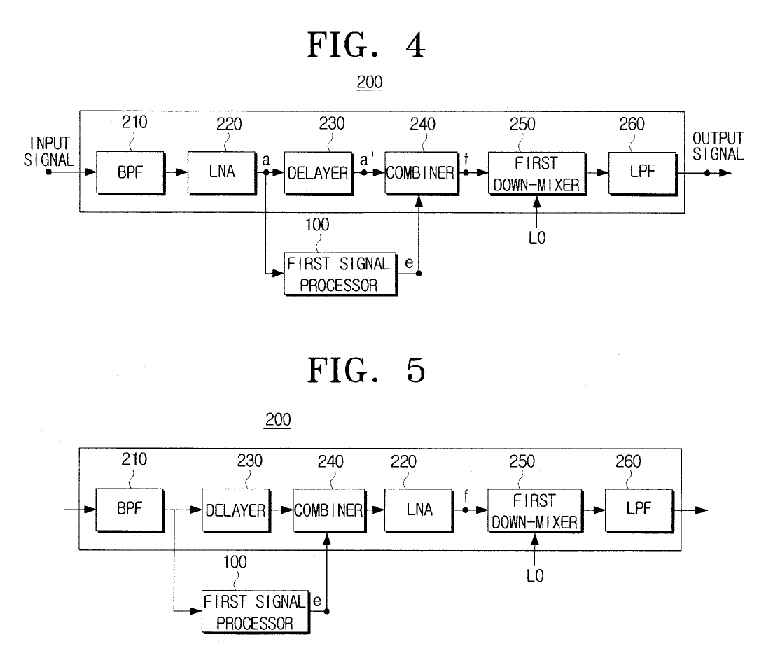

FIG. 4 is a detailed block diagram showing the second signal processor 200 of FIG. 3. The RF receiver shown in FIG. 4 comprises the first signal processor 100 and the second signal processor 200. The second signal processor 200 of FIG. 4 further comprises a band pass filter (BPF) 210, a low noise amplifier (LNA) 220, a first down-mixer 250 and a low pass filter (LPF) 260, together with the delayer 230 and combiner 240 shown in FIG. 3.

The RF signals received by the RF receiver via an antenna (not shown) comprise desired signals and interference signals adjacent to the desired signals. The BPF 210 receives the RF signals received by the RF receiver via the antenna (not shown), and roughly filters the received RF signals at frequency band adjacent to the desired signals. However, in RF communication, baseband signals are modulated to high-frequency passband signals and the modulated signals are transmitted, and accordingly the entire frequency bandwidth comprising bandwidth of both the desired signals and interference signals may have a much lower value than the central frequency of the desired signals. As a result, even when the desired signals are filtered from the RF signals by the BPF 210, the undesired signals, that is, interference signals may also be detected.

The signals output from the BPF 210 are input to the LNA 220. The LNA 220 amplifies the signals filtered by the BPF 210 while suppressing noise of the filtered signal, and outputs the amplified signals to the delayer 230. The signals output from the LNA 220 are delayed by the predetermined time period through the delayer 230.

The signals output from the delayer 230 are then combined with the signals output from the first signal processor 100 by the combiner 240.

Next, the combined signal output from the combiner 240 is mixed with a signal of a local oscillator, which generates a signal having a predetermined frequency L0, in the first down-mixer 250, to be down-converted to baseband.

The signal down-converted to baseband is filtered by the LPF 260, so that high frequency components, namely, undesired signals, may be removed. Accordingly, it is possible to select only the desired signals by filtering operation.

The first signal processor 100 will be described in detail later.

FIG. 5 is a block diagram showing a second signal processor 200 of an RF receiver according to another exemplary embodiment of the present invention. The BPF 210, LNA 220, delayer 230, combiner 240, first down-mixer 250, LPF 260 and first signal processor 100 shown in FIG. 5 are the same as those in FIG. 4, except that the LNA 220 of FIG. 5 is disposed between the combiner 240 and the first down-mixer 250, so further description thereof will be omitted.

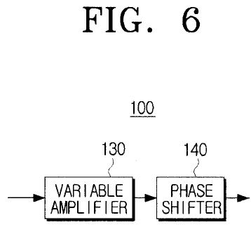

FIG. 6 is a block diagram showing the first signal processor 100 of the RF receiver according to the exemplary embodiment of the present invention. The first signal processor 100 of FIG. 6 comprises a variable amplifier 130 and a phase shifter 140. The variable amplifier 130 of FIG. 6 amplifies the received signals, to control the amplitude of the received signals. The variable amplifier 130 may be a variable gain amplifier (VGA) capable of optionally adjusting the gain, or an amplifier capable of automatically controlling the gain, or may desirably be an attenuator. Specifically, if the amplitude of interference signals, namely, undesired signals, is greater than that of the interference signals that have been received, the amplitude of the undesired signals may be reduced so that all the interference signals may have the same amplitude.

The phase shifter 140 converts the phase of the signals output from the variable amplifier 130. In more detail, the variable amplifier 130 controls the amplitude of interference signals, and the phase shifter 140 controls the phase of interference signals. Accordingly, the interference signals may have the same amplitude as the interference signals output from the delayer 230 of the second signal processor 200, and may be shifted in phase by 180°, and thus it is possible to remove interference signals that are undesired signals disposed adjacent to desired signals.

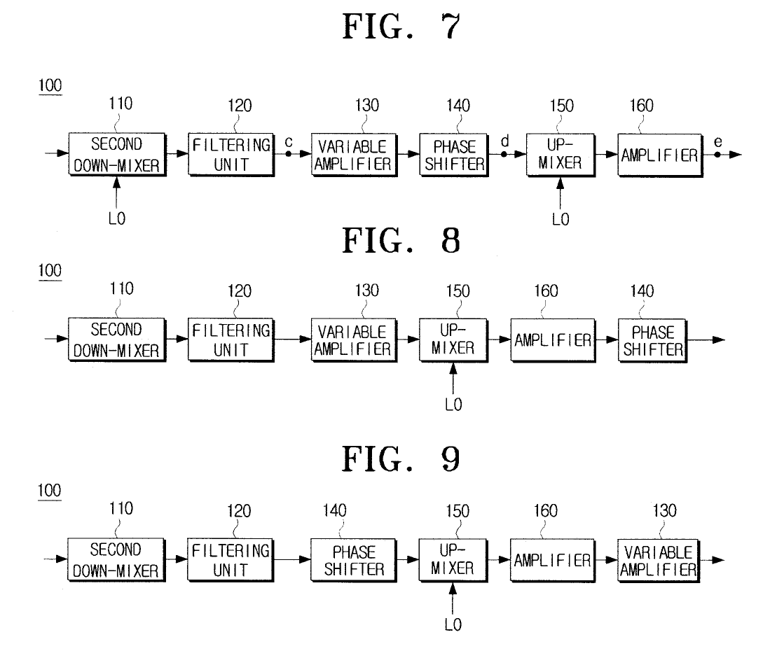

FIG. 7 is a detailed block diagram showing the first signal processor 100 shown in FIG. 6. The first signal processor 100 of FIG. 7 comprises not only the variable amplifier 130 and phase shifter 140 shown in FIG. 6, but also a second down-mixer 110, a filtering unit 120, an up-mixer 150 and an amplifier 160.

The second down-mixer 110 mixes the signals output from the LNA 220 of the second signal processor 200 with a signal having a local frequency, to down-convert the frequency of the signals output from the LNA 220 to baseband. The signals output from the second down-mixer 110 comprise not only desired signals but also interference signals, that is, undesired signals.

The filtering unit 120 selectively filters only interference signals having relatively large amplitude from the signals, which are down-converted to baseband by the second down-mixer 110. A filter of the filtering unit 120 may be a band rejection filter or a high-pass filter which is used to select only undesired signals. Additionally, the filtering unit 120 of the first signal processor 100 may have a cut-off frequency identical to that of the LPF 260 of the second signal processor 200, and it is thus possible to restore the RF signals exactly.

The amplitude of undesired signals filtered by the filtering operation is controlled by the variable amplifier 130, and the phase thereof is controlled by the phase shifter 140, as described above.

The up-mixer 150 mixes the signal output from the phase shifter 140 with a signal having a local frequency L0, to up-convert the signal output from the phase shifter 140 to passband. The up-mixer 150 may desirably be used to increase the frequency of a single side band. Therefore, signals may be synthesized in passband in the same manner as the signals delayed by the delayer 230 of the second signal processor 200.

The amplifier 160 amplifies the signals output from the up-mixer 150.

FIG. 8 is a block diagram showing a first signal processor 100 of the RF receiver according to another exemplary embodiment of the present invention. The second down-mixer 110, filtering unit 120, variable amplifier 130, phase shifter 140, up-mixer 150 and amplifier 160 of FIG. 8 are the same as those in FIG. 7, except that the phase shifter 140 is disposed next to the amplifier 160, so further description thereof will be omitted.

FIG. 9 is a block diagram showing a first signal processor 100 of an RF receiver according to yet another exemplary embodiment of the present invention. The second down-mixer 110, filtering unit 120, variable amplifier 130, phase shifter 140, up-mixer 150 and amplifier 160 of FIG. 9 are the same as those in FIG. 7, except that the variable amplifier 130 is disposed next to the amplifier 160, so further description thereof will be omitted.

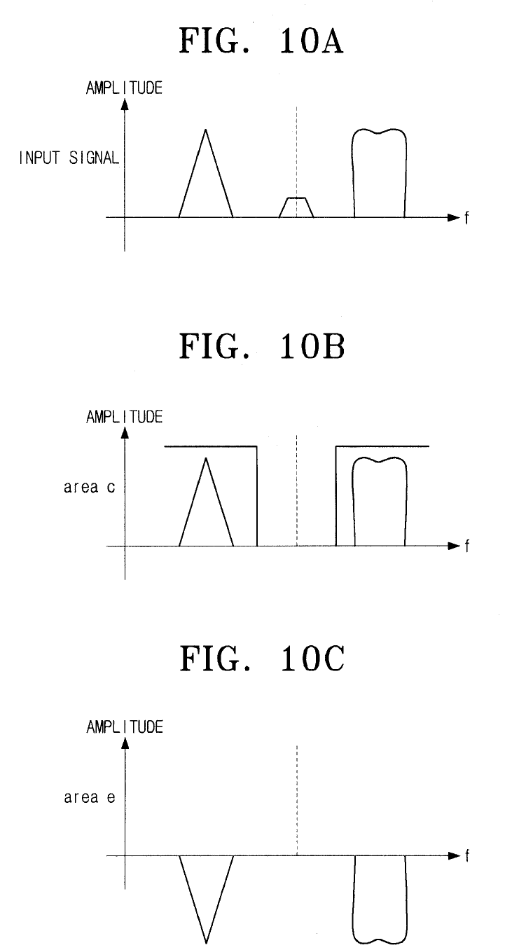

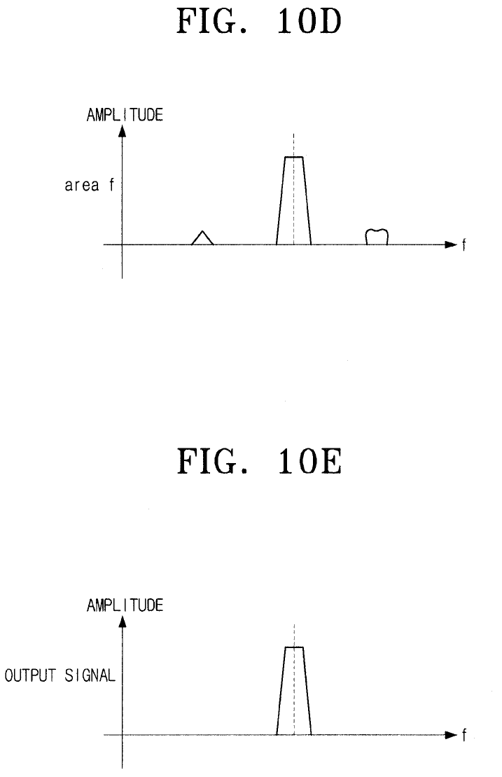

FIGS. 10A to 10E are graphical representations showing representative signal waveforms at areas of the RF receiver according to the exemplary embodiments of the present invention. Hereinafter, the graphs of FIGS. 10A to 10E will be explained with reference to FIGS. 4 and 7. Referring to FIG. 10A, signals transmitted via an antenna (not shown), that is, input signals, comprise desired signals and undesired signals. The signals output from the BPF 210 and LNA 220 also comprise undesired signals. The input signals may be expressed using the following Equation 1.

a=U₁ cos(ωᵤ₁t)+D cos(ωₐ^{t})+U₃ cos(ωᵤ₃t),ωᵤ₁<ω_{d}<ωᵤ₃ [Equation 1]

In Equation 1, the first component, which has a frequency of ωᵤ₁, and the third component, which has a frequency of ωᵤ₃, may be undesired signals, and the second component, which has a frequency of ω_{d}, may be a desired signal.

The input signals are input to the second signal processor 200, and the frequency thereof is down-converted to baseband. The input signals down-converted to baseband may be expressed using the following Equation 2.

b=a×A_{LO} cos(ω_{LO}t) [Equation 2]

In Equation 2, ω_{L0} represents a local frequency. If Equation 1 is substituted into Equation 2, Equation 2 may be rewritten in the following form:

$$b = \frac{{U}_{1} {A}_{LO}}{2} [ cos ( {ω}_{u 1} t + {ω}_{LO} t ) + cos ( {ω}_{u 1} t - {ω}_{LO} t ) ] + \frac{{DA}_{LO}}{2} [ cos ( {ω}_{d} t + {ω}_{LO} t ) + cos ( {ω}_{d} t - {ω}_{LO} t ) ] + \frac{{U}_{3} {A}_{LO}}{2} [ cos ( {ω}_{u 3} t + {ω}_{LO} t ) \_cos ( {ω}_{u 3} t - {ω}_{LO} t ) ]$$

Since the input signals are down-converted to baseband, the frequency intervals between the desired signals and the undesired signals may be expanded. Accordingly, it is easier to perform filtering in order to select only undesired signals. If filtering is performed using Equation 2, the following Equation 3 may be obtained.

$$c = \frac{( {U}_{1} {A}_{LO} )}{2} cos ( {ω}_{u 1} t - {ω}_{LO} t ) + \frac{( {U}_{3} {A}_{LO} )}{2} cos ( {ω}_{u 3} t - {ω}_{LO} t ) \qquad [ Equation 3 ]$$

Referring to FIGS. 7 and 10B, a signal waveform is shown at area c of FIG. 7 in which only undesired signals (namely, interference signals) are filtered. Accordingly, only undesired signals may be selected, as shown in the waveform of FIG. 10B.

The signals at area d of FIG. 7 output from the variable amplifier 130 and phase shifter 140 may be defined by Equation 4.

$$d = G 1 \times \frac{( {U}_{1} {A}_{LO} )}{2} cos ( {ω}_{u 1} t - {ω}_{LO} t - φ ) + G 1 \times \frac{( {U}_{3} {A}_{LO} )}{2} cos ( {ω}_{u 3} t - {ω}_{LO} t - φ ) \qquad [ Equation 4 ]$$

In Equation 4, G1 represents the gain of the variable amplifier 130, and φ represents the phase shifted by the phase shifter 140. In other words, the variable amplifier 130 may set the size of the amplitude of the signals equal to the amplitude of the signals output from the delayer 230 of the second signal processor 200. Additionally, the phase shifter 140 may set the phase of the signals so that the signals may be shifted in phase by 180° from the signals output from the delayer 230 of the second signal processor 200.

The frequency of the signals is up-converted to passband by the up-mixer 150 again, and the interference signals are amplified by the amplifier 160. In this situation, a signal waveform at area e shown in FIGS. 4 and 7 may be expressed using the following Equation 5.

e=d×A_{LO} cos(ω_{LO}^{t})×G2 [Equation 5]

In Equation 5, G2 represents the gain of the amplifier 160. Equation 5 may be rewritten in the following form:

$$e = \frac{G 1 G 2 {U}_{1} {A}_{LO}^{2}}{4} cos ( {ω}_{u 1} t - φ ) + \frac{G 1 G 2 {U}_{3} {A}_{LO}^{2}}{4} cos ( {ω}_{u 3} t - φ )$$

Here, the signals output from the delayer 230 of the second signal processor 200 may be expressed as the following Equation 6.

a′=U₁ cos(ωᵤ₁t−θ)+D cos(ω_{d}t−θ)+U₃ cos(ωᵤ₃t−θ) [Equation 6]

In Equation 6, θ represents the time delayed by the delayer 230. Additionally, the signals output through the combiner 240 may be expressed as the following Equation 7.

$$\begin{matrix}f = {a}^{′} + e = {U}_{1} cos ( {a}_{u 1} t - θ ) + D cos ( {ω}_{d} t - θ ) - {U}_{3} cos ( {ω}_{u 3} t - θ ) - \frac{G 1 G 2 {U}_{1} {A}_{LO}^{2}}{4} cos ( {ω}_{u 1} t - φ ) + \frac{G 1 G 2 {U}_{3} {A}_{LO}^{2}}{4} cos ( {ω}_{u 3} t - φ ) & [ Equation 7 ] \\ {U}_{1} = \frac{G 1 G 2 {U}_{1} {A}_{LO}^{2}}{4} , {U}_{3} = \frac{G 1 G 2 {U}_{3} {A}_{LO}^{2}}{4} , θ - φ = 180 ° & [ Equation 8 ]\end{matrix}$$

Accordingly, if the gain and phase of FIG. 7 is adjusted using Equation 8, the signals output through the combiner 240 and the undesired signals from among the signals output from the delayer 230 of the second signal processor 200 may differ in phase by 180°, and the size of the amplitudes thereof may be equal, as shown in FIG. 10C.

As shown in area f of FIG. 4 and FIG. 10D, the desired signals from among the signals through the combiner 240 of the second signal processor 200 have greater amplitudes than the input signals, but have the same waveform as the input signals. Additionally, the undesired signals from among the signals through the combiner 240 of the second signal processor 200 have less amplitudes than the input signals, but have the same waveform as the input signals. The frequency of the signals from the combiner 240 is down-converted to baseband by the first down-mixer 250, and the undesired signals (that is, the interference signals) are then removed using the LPF 260, and accordingly only the desired signals having the amplified amplitudes may be restored (FIG. 10E).

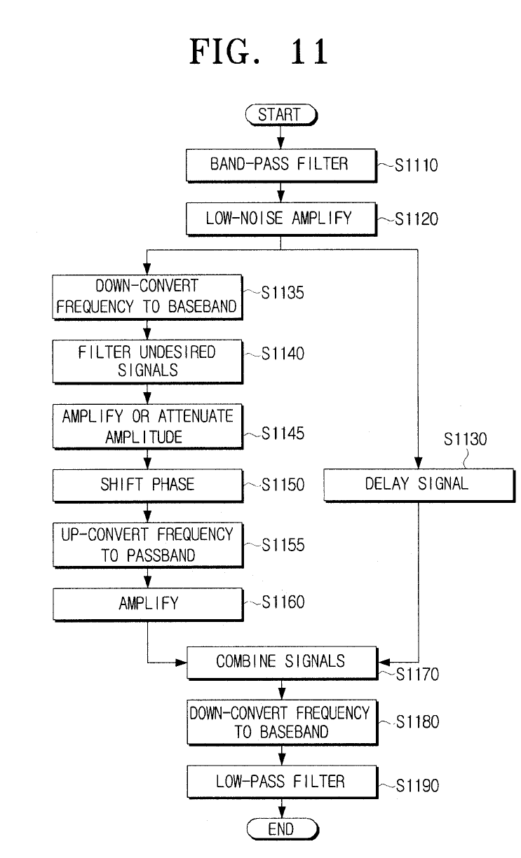

FIG. 11 is a flowchart explaining a method by which the RF receiver removes interference signals, according to the exemplary embodiments of the present invention. In FIG. 11, if RF signals are received, band-pass filtering may be performed with respect to the received RF signals (S1110), and amplifying may then be performed for the filtered signals in order to minimize noise (S1120), followed by separately transferring the amplified signals through two routes. A first signal of the amplified signals to be transferred through a first route may be delayed until a second signal of the amplified signals is transferred through a second route (S1130).

The second signal transferred through the second route may be mixed with a local frequency signal so that the frequency of the second signal may be down-converted to baseband (S1135). Only undesired signals may be selectively filtered from the down-converted signals in order to selectively output only the undesired signals, and not the desired signals (S1140), and the amplitude (gain) of undesired signals may be variably amplified or attenuated (S1145). After the amplitude of undesired signals has been controlled, the phase of undesired signals may be shifted by 180° compared with the phase of the received RF signals (S1150). Next, the undesired signals may be mixed with the local frequency signal, so that the undesired signals may be up-converted to passband (S1155). The undesired signals may then be amplified so that the amplitude thereof may be controlled (S1160).

The undesired signals of which the amplitude has been controlled may be combined with the first signal delayed at operation S1130 (S1170). The combined signal may be down-converted to baseband again (S1180), so that only desired signals may be selected using low-pass filtering (S1190).

The exemplary embodiments of the present invention related to the method by which the RF receiver removes interference signals have been already described in detail, so further description thereof will be omitted.

According to the exemplary embodiments of the present invention, it is possible to remove undesired signals existing in channels in which there is no overlap in frequency between desired signals and undesired signals, and accordingly an RF receiver having enhanced performance and a method by which the RF receiver removes interference signals may be provided. Additionally, there is no need to use two antennas and two systems separately, so the manufacturing costs may be reduced.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A radio frequency (RF) receiver comprising:
a first signal processor which detects an undesired signal from RF signals received through a channel, to convert the phase of the detected signal; and
a second signal processor which combines the signal output from the first signal processor with the received RF signals, to detect a desired signal.

2. The RF receiver as claimed in claim 1, wherein the second signal processor comprises:
a delayer which delays the received RF signals; and
a combiner which combines the signal output from the delayer with the signal output from the first signal processor.

3. The RF receiver as claimed in claim 2, wherein the second signal processor further comprises:
a band pass filter (BPF) which filters the received RF signals;
a low noise amplifier (LNA) which low-noise amplifies the filtered signal and outputs the amplified signal to the delayer;
a first down-mixer which mixes a local frequency signal with the signal output from the combiner to convert the frequency of the signal output from the combiner to baseband; and
a low pass filter (LPF) which filters the signal output from the first down-mixer.

4. The RF receiver as claimed in claim 2, wherein the second signal processor further comprises:
a band pass filter (BPF) which filters the received RF signals and outputs the filtered signal to the delayer;
a low noise amplifier (LNA) which low-noise amplifies the signal output from the combiner;
a first down-mixer which mixes a local frequency signal with the signal output from the LNA to convert the frequency of the signal output from the LNA to baseband; and
a low pass filter (LPF) which filters the signal output from the first down-mixer.

5. The RF receiver as claimed in claim 1, wherein the first signal processor comprises a variable amplifier which amplifies the received RF signals to control the amplitude of the received RF signals.

6. The RF receiver as claimed in claim 5, wherein the first signal processor further comprises:
a second down-mixer which mixes the received RF signals with a local frequency signal to convert the frequency of the received RF signals to baseband;
a filtering unit which filters the signal output from the second down-mixer and outputs the filtered signal to the variable amplifier;
a phase shifter which converts the phase of the signal output from the variable amplifier;
an up-mixer which mixes the signal output from the phase shifter with the local frequency signal to up-convert the frequency of the signal output from the phase shifter; and
an amplifier which amplifies the signal output from the up-mixer.

7. The RF receiver as claimed in claim 5, wherein the first signal processor further comprises:
a second down-mixer which mixes the received RF signals with a local frequency signal to down-convert the frequency of the received RF signals;
a filtering unit which filters the signal output from the second down-mixer and outputs the filtered signal to the variable amplifier;
an up-mixer which mixes the signal output from the variable amplifier with the local frequency signal to up-convert the frequency of the signal output from the variable amplifier;
an amplifier which amplifies the signal output from the up-mixer; and
a phase shifter which converts the phase of the signal output from the amplifier.

8. The RF receiver as claimed in claim 1, wherein the first signal processor further comprises:
a second down-mixer which mixes the received RF signals with a local frequency signal to down-convert the frequency of the received RF signals;
a filtering unit which filters the signal output from the second down-mixer;
a phase shifter which converts the phase of the signal output from the filtering unit;
an up-mixer which mixes the signal output from the phase shifter with the local frequency signal to up-convert the frequency of the signal output from the phase shifter;
an amplifier which amplifies the signal output from the up-mixer; and
a variable amplifier which amplifies the signal output from the amplifier to control the amplitude of the signal output from the amplifier.

9. The RF receiver as claimed in claim 1, wherein the first signal processor further comprises a filtering unit, the second signal processor further comprises a low pass filter (LPF), and a cut-off frequency of the filtering unit equals that of the LPF.

10. The RF receiver as claimed in claim 1, further comprising a local oscillator, which generates a local frequency signal,
wherein each of the first signal processor and second signal processor comprise one or more mixers which perform mixing using the same local frequency signal generated by the local oscillator.

11. The RF receiver as claimed in claim 1, wherein the first signal processor converts the phase of the detected undesired signal, and
the second signal processor combines the undesired signal, of which the phase has been converted, with the RF signals, and offsets the undesired signal from the RF signals, to detect the desired signal.

12. A method by which a radio frequency (RF) receiver removes an interference signal, the method comprising:
detecting an undesired signal from RF signals received through a channel, to convert the phase of the detected signal; and
combining the undesired signal, of which the phase has been converted, with the received RF signals, and offsetting the undesired signal from the RF signals, to detect a desired signal.

13. The method as claimed in claim 12, wherein the combining comprises:
delaying the received RF signals; and
combining the delayed signals with the undesired signal of which the phase has been converted.

14. The method as claimed in claim 13, wherein the combining further comprises:
band-pass filtering the received RF signals;
low-noise amplifying the filtered signal and outputting the amplified signal;
mixing a local frequency signal with the combined signal to convert the frequency of the combined signal to baseband; and
low-pass filtering the signal of which the frequency has been converted to baseband.

15. The method as claimed in claim 13, wherein the combining further comprises:
band-pass filtering the received RF signals and outputting the filtered signal;
low-noise amplifying the combined signal;
mixing a local frequency signal with the low-noise amplified signal to convert the frequency of the low-noise amplified signal to baseband; and
low-pass filtering the signal of which the frequency has been converted to baseband.

16. The method as claimed in claim 12, wherein the detecting comprises amplifying the received RF signals to control the amplitude of the received RF signals.

17. The method as claimed in claim 16, wherein the detecting further comprises:
mixing the received RF signals with a local frequency signal to convert the frequency of the received RF signals to baseband;
filtering the RF signals of which the frequency has been converted to baseband and outputting the filtered signal;
mixing the signal of which the phase has been converted with the local frequency signal to convert the frequency of the signal, of which the phase has been converted, to passband; and
amplifying the signal of which the frequency has been converted to passband.

18. The method as claimed in claim 16, wherein the detecting further comprises:
mixing the received RF signals with a local frequency signal to convert the frequency of the received RF signals to baseband;
filtering the RF signals of which the frequency has been converted to baseband and outputting the filtered signal;
mixing the signal of which the amplitude has been controlled with the local frequency signal to convert the frequency of the signal, of which the amplitude has been controlled, to passband;
amplifying the signal of which the frequency has been converted to passband; and
converting the phase of the amplified signal.

19. The method as claimed in claim 12, wherein the detecting comprises:
mixing the received RF signals with a local frequency signal to convert the frequency of the received RF signals to baseband;
filtering the RF signals of which the frequency has been converted to baseband;
converting the phase of the filtered signal;
mixing the signal of which the phase has been converted with the local frequency signal to convert the frequency of the signal, of which the phase has been converted, to passband; and
amplifying the signal of which the frequency has been converted to passband.

20. The method as claimed in claim 12, wherein the detecting comprises filtering, the combining comprises low-pass filtering, and the filtering and low-pass filtering are performed using the same cut-off frequency.

21. The method as claimed in claim 12, further comprising generating a local frequency signal,
wherein the detecting and the combining comprise performing mixing using the same generated local frequency signal to control at least one frequency.

22. The method as claimed in claim 12, wherein the detecting comprises converting the phase of the detected undesired signal, and
the combining comprises combining the undesired signal, of which the phase has been converted, with the RF signals, to detect the desired signal.
